(19) United States
(12) Patent Application Publication
(10) Pub. No.: US 2026/0060256 A1
(43) Pub. Date: Mar. 5, 2026

(54) FIBER MATERIAL WITH ANTIBACTERIAL FUNCTION AND PREPARATION METHOD THEREOF

(71) Applicants: Donghua University, Shanghai (CN); Dawnsens New Materials (Xiamen) Co., Ltd., Xiamen City (CN)

(72) Inventors: Hengxue XIANG, Shanghai (CN); Jinqi WANG, Shanghai (CN); Gongxun ZHAI, Shanghai (CN); Meifang ZHU, Shanghai (CN); Qianqin ZHU, Shanghai (CN); Huifei ZHU, Shanghai (CN); Zhangsheng LUO, Shanghai (CN); Senlong YU, Shanghai (CN); Zexu HU, Shanghai (CN)

(21) Appl. No.: 18/956,552

(22) Filed: Nov. 22, 2024

(30) Foreign Application Priority Data
Sep. 2, 2024 (CN) 202411224059.9

(51) Int. Cl. A01N 59/00; A01N 25/10; A01N 25/34; A01P 1/00

(52) U.S. Cl. CPC A01N 59/00; A01N 25/10; A01N 25/34; A01P 1/00

(57) ABSTRACT

Provided is a fiber material with antibacterial function and a preparation method thereof. Processes of synthesizing an antibacterial agent, dissolving a polymer, uniformly dispersing the antibacterial agent in the polymer and the like are combined into one step, which could be completed in the same one reactor. The in-situ preparation of the antibacterial agent and the dissolution of the polymer could be realized by using the same solvent skillfully, having advantages of saving time and labor.

### CROSS-REFERENCE TO RELATED APPLICATION

This patent application claims the benefit and priority of Chinese Patent Application No. 2024112240599 filed with the China National Intellectual Property Administration on Sep. 2, 2024, the disclosure of which is incorporated by reference herein in its entirety as part of the present application.

### TECHNICAL FIELD

The present disclosure relates to the technical field of antibacterial materials, in particular to a fiber material with antibacterial function and a preparation method thereof.

### BACKGROUND

In the field of antibacterial materials, protective materials, such as masks and protective clothing, intercept carriers containing bacteria or viruses outside the body through physical isolation to avoid body damage caused by subsequent infections. At present, protective equipment is mainly made of microfiber textile materials, which does not have the characteristics of sterilization and antivirus. The combination of antibacterial agents and protective materials is the key to realize the conversion of protective materials from physical protection to active protection of bacteriostasis and sterilization. Metal oxides such as titanium dioxide have the characteristics of stability, low cost, strong heat resistance and semiconductivity. Under the irradiation of sunlight, photoelectrons with energy greater than the band gap are captured, generating photo-generated electron-hole pairs with redox properties. The photo-generated electron-hole pairs migrate to the surface of the metal oxide, and react with external water molecules or oxygen to generate active substances, which could further react with bacterial cell walls to kill bacteria.

A conventional idea and method to combine antibacterial agents and textile materials is to prepare antibacterial agents first, and then prepare antibacterial non-woven materials by physical blending, surface coating or plasma treatment, or textile processing post-treatment. The preparation process is divided into several discontinuous steps, which has the disadvantages of time-consuming, labor-consuming, and occupying multiple sets of equipment.

### SUMMARY

In view of this, an object of the present disclosure is to provide a fiber material with antibacterial function and preparation method thereof. The present disclosure combines a plurality of steps into one step, which greatly saves the production and labor costs, and the prepared fiber material has the advantages of great and lasting antibacterial property.

In order to achieve the above object, the present disclosure provides the following technical solutions:

Provided is a method for preparing a fiber material with antibacterial function, including:
mixing raw materials comprising a titanium source, an alkyl alcohol solvent, a chemical reactant, a cosolvent and polymer particles to obtain a mixture;
under a sealed condition and with a first stirring, heating the mixture to a temperature of 170-200° C., and conducting a reaction at the temperature for 5-10 h; wherein during the reaction, the titanium source and the alkyl alcohol solvent form a titanium alcohol complex, and the titanium alcohol complex is dehydrated under an action of the chemical reactant to form TiO₂; and the chemical reactant comprises at least one selected from the group consisting of N, N-dimethylformamide and N, N-dimethylacetamide;
pressurizing a resulting reaction system to a pressure of 7-15 MPa, and performing a second stirring at an increased stirring speed than that of the first stirring for 1-1.5 h such that the polymer particles become a polymer fluid and that a nano-flower-shaped TiO₂ is formed by an impact from the polymer fluid and the alkyl alcohol solvent, to obtain a spinning solution; and
spraying the spinning solution by releasing the pressure through spinneret holes, and volatilizing solvents to form polymer fibers, obtaining the fiber material with antibacterial function.

In some embodiments, the titanium source is at least one selected from the group consisting of titanium(iv) tert-butoxide, titanium tetrachloride, and titanium sulfate.

In some embodiments, the alkyl alcohol solvent has 5 or less carbon atoms.

In some embodiments, the polymer particles comprise at least one selected from the group consisting of polyethylene particles, polypropylene particles, polyester particles and polyamide particles.

In some embodiments, the cosolvent comprises at least one selected from the group consisting of dichloroethane and dichloromethane.

In some embodiments, based on 100% in terms of a mass of the raw materials, the titanium source accounts for 5-8%, the chemical reactant accounts for 25-35%, the alkyl alcohol solvent accounts for 30-37%, the cosolvent accounts for 10-15%, and the polymer particles account for 5-30%.

In some embodiments, the first stirring is conducted at a stirring speed of 20-40 r/min; and the second stirring is conducted at a stirring speed of 100-200 r/min.

In some embodiments, a gas used in the pressurizing is at least one selected from the group consisting of argon, nitrogen, and carbon dioxide.

In some embodiments, after the polymer fibers are formed, the method further comprises: subjecting the polymer fibers to airflow splitting and collecting resulting split fibers by a conveyor belt.

Further provided is a fiber material with antibacterial function prepared by the method described in above technical solutions, comprising polymer fibers, wherein nano-flower-shaped TiO₂ is distributed on the surface of the polymer fibers.

In the present disclosure, a method for preparing a fiber material with antibacterial function is provided. The method includes: mixing raw materials comprising a titanium source, an alkyl alcohol solvent, a chemical reactant, a cosolvent and polymer particles to obtain a mixture; under a sealed condition and with a first stirring, heating the mixture to a temperature of 170-200° C., and conducting a reaction at the temperature for 5-10 h; wherein during the reaction, the titanium source and the alkyl alcohol solvent form a titanium alcohol complex, and the titanium alcohol complex is dehydrated under an action of the chemical reactant to form TiO₂; and the chemical reactant comprises at least one of N,N-dimethylformamide and N,N-dimethylacetamide; and pressurizing a resulting reaction system to a pressure of 7-15 MPa, and performing a second stirring at an increased stirring speed than that of the first stirring for 1-1.5 h such that the polymer particles become a polymer fluid and that a nano-flower-shaped TiO₂ is formed by an impact from the polymer fluid and the alkyl alcohol solvent, to obtain a spinning solution; and spraying the spinning solution by releasing the pressure through spinneret holes, and volatilizing solvents to form polymer fibers, obtaining the fiber material with antibacterial function.

In the present disclosure, after the raw materials are mixed, the mixture is heated to a temperature of 170-200° C. The titanium source is uniformly dispersed in the alkyl alcohol solvent to form a titanium alcohol complex with the alkyl alcohol solvent. Then, the titanium alcohol complex is dehydrated under the action of the chemical reactant to form TiO₂. In a critical state, the polymer particles become a polymer fluid. Because of viscosity difference between the polymer fluid and the solvent, TiO₂ is repeatedly impacted irregularly by the solvent and the polymer fluid, forming flow marks on surfaces of TiO₂ particles, which is similar to surfaces of shellfish in tidal area (washed by sand and seawater together), and meanwhile it is guaranteed that TiO₂ particles do not collide seriously with other TiO₂ particles, resulting in that TiO₂ shows a nano-flower-shaped morphology finally.

In the whole preparation process, processes of synthesizing an antibacterial agent, dissolving a polymer, uniformly dispersing the antibacterial agent in the polymer and the like are combined into one step, which could be completed in the same one reactor. The in-situ preparation of the antibacterial agent and the dissolution of the polymer could be realized by using the same solvent skillfully, having advantages of saving time and labor.

The antibacterial agent titanium dioxide supported by the fiber material prepared by the present disclosure has the characteristics of nano-flower shape and large specific surface area. Firstly, the antibacterial agent titanium dioxide could fully contact and absorb natural light, generate active oxygen (hydroxyl radical, superoxide radical and photogenerated hole) substances, and destroy the activity of bacteria, thereby inhibiting bacteria and killing bacteria. Secondly, owing to the irregular surfaces of the antibacterial agent, the antibacterial agent could be easily embedded on surfaces of the polymer, and has strong interfacial bonding force with the polymer, making the antibacterial agent not easy to be fallen off, thereby realizing a lasting antibacterial effect of the fiber material.

The fiber material prepared by the present disclosure could be in a form of a single fiber, or in a form of a non-woven material after being split and collected.

In the present disclosure, after the polymer fiber is formed, the polymer fiber could further be subjected to airflow splitting. The spinning solution is formed into microfibers under pulling force, such that the obtained non-woven material has good antibacterial property and good air permeability, and is comfortable to wear, which could be used to prepare protective clothing for preventing hospital bacterial infection, treating special medical accidents and other scenes for a long time.

In the present disclosure, the method for preparing the fiber material has short process and simple operation, and is easy to be performed, which has strong applicability, making it possible to be used to prepare starting materials for protective clothing, masks or other protective devices quickly in large quantities to cope with sudden health and safety accidents.

The results of the Examples show that the non-woven material prepared by the present disclosure shows an air permeability of 200-400 mm/s, a longitudinal breaking strength of >200 N, and a transverse breaking strength of >150 N, showing excellent antibacterial effect. The non-woven material of the present disclosure has antibacterial rates against Escherichia coli, Staphylococcus aureus and Helicobacter pylori of all greater than 99.8%, and an antiviral activity rate against RNA virus H1N1 reaching 98.24%.

### BRIEF DESCRIPTION OF THE DRAWINGS

FIG. 1 shows a schematic diagram of the device used for preparing antibacterial non-woven materials in Examples 1-2 and Comparative Example 1 of the present disclosure, where 1 represents a stirring device, 2 represents a feeding port, 3 represents a reaction device, 4 represents a spinneret hole, 5 represents a splitting device, 6 represents a collecting device and 7 represents an antibacterial non-woven material.

FIG. 2A shows a surface morphology of the non-woven material of Example 1.

FIG. 2B shows a morphology of the microfiber of Example 1.

FIG. 3A shows a morphology diagram of an aggregation state of the antibacterial agent of Example 2.

FIG. 3B shows a surface morphology of the antibacterial agent of Example 2.

FIG. 4A shows a surface morphology of the antibacterial non-woven material of Example 2.

FIG. 4B shows an enlarged surface morphology of the antibacterial non-woven material of Example 2.

FIG. 5A shows mechanical properties of the non-woven materials in Example 1.

FIG. 5B shows mechanical properties of the non-woven materials in Example 2.

FIG. 5C shows mechanical properties of the non-woven materials in Comparative Example 1.

FIG. 6A shows electron paramagnetic resonance spectra of the non-woven material in Comparative Example 1 and the antibacterial non-woven material in Example 2 under light irradiation, where spin trapping agents are ·OH.

FIG. 6B shows electron paramagnetic resonance spectra of the non-woven material in Comparative Example 1 and the antibacterial non-woven material in Example 2 under light irradiation, where spin trapping agents are h⁺.

FIG. 6C shows electron paramagnetic resonance spectra of the non-woven material in Comparative Example 1 and the antibacterial non-woven material in Example 2 under light irradiation, where spin trapping agents are ·O₂⁻.

FIG. 7 shows antibacterial performance diagrams of the antibacterial non-woven material of Example 2, where panel a corresponds to a blank control, and panels b to d represent inhibition effect diagrams against Escherichia coli colonies at different concentrations; specifically, panel b corresponds to 0.075 mg/mL, panel c corresponds to 0.1 mg/mL, panel d corresponds to 0.125 mg/mL, panel e corresponds to 0.15 mg/mL and panel f corresponds to 0.175 mg/mL.

### DETAILED DESCRIPTION OF THE EMBODIMENTS

The present disclosure provides a method for preparing a fiber material with antibacterial function, including:
mixing raw materials comprising/consisting of a titanium source, an alkyl alcohol solvent, a chemical reactant, a cosolvent and polymer particles to obtain a mixture;
under a sealed condition and with a first stirring, heating the mixture to a temperature of 170-200° C., and conducting a reaction at the temperature for 5-10 h; wherein during the reaction, the titanium source and the alkyl alcohol solvent form a titanium alcohol complex, and the titanium alcohol complex is dehydrated under an action of the chemical reactant to form TiO₂; and the chemical reactant comprises at least one selected from the group consisting of N, N-dimethylformamide and N,N-dimethylacetamide;
pressurizing a resulting reaction system to a pressure of 7-15 MPa, and performing a second stirring at an increased stirring speed than that of the first stirring for 1-1.5 h, such that the polymer particles become a polymer fluid and that a nano-flower-shaped TiO₂ is formed by an impact from the polymer fluid and the alkyl alcohol solvent, to obtain a spinning solution; and
spraying the spinning solution by releasing the pressure through spinneret holes, and volatilizing solvents to form polymer fibers, obtaining the fiber material with antibacterial function.

In the present disclosure, unless otherwise specified, all the raw materials used are well-known commercial commodities in the art.

In the present disclosure, a titanium source, an alkyl alcohol solvent, a chemical reactant, a cosolvent and a polymer particles are mixed to obtain a mixture.

In the present disclosure, in some embodiments, the titanium source is at least one selected from the group consisting of titanium(iv) tert-butoxide, titanium tetrachloride and titanium sulfate. In some embodiments, the alkyl alcohol solvent has 5 or less carbon atoms, and preferably is isopropanol, ethylene glycol, n-propanol or a mixture thereof. In the present disclosure, the alkyl alcohol solvent has two functions: one is to form a titanium alcohol complex with the titanium source, and the other is to reduce interfacial tension of the polymer in the solvent at high temperature and high pressure.

In the present disclosure, in some embodiments, the chemical reactant includes at least one of N,N-dimethylformamide and N,N-dimethylacetamide. In some embodiments, the cosolvent includes at least one of dichloroethane and dichloromethane. In the present disclosure, the cosolvent is used for improving a cloud point pressure of the spinning solution. In the present disclosure, in some embodiments, the polymer particles include at least one of polyethylene particles, polypropylene particles, polyester particles and polyamide particles. In some embodiments, polymer itself of the polymer particles has a viscosity of 1000-45000 mPa·s (the viscosity is measured by GB/T 1632.1-2008, determination of the viscosity of polymers in dilute solution using capillary viscometers, at 25° C. and atmospheric pressure).

In the present disclosure, in some embodiments, based on 100% in terms of a mass of the raw materials, the titanium source accounts for 5-8%, and preferably 6-7%; the chemical reactant accounts for 25-35%, and preferably 28-32%; the alkyl alcohol solvent accounts for 30-37%, and preferably 32-35%; the cosolvent accounts for 10-15%, and preferably 12-14%; and the polymer particles account for 5-30%, preferably 10-25%, and more preferably 15-20%.

In the present disclosure, in some embodiments, the polymer particles are dried first and then mixed. There is no special requirement on the drying temperature, any drying temperature well known in the art may be used. In one Example of the present disclosure, the drying temperature is 60° C.

In the present disclosure, in some embodiments, the mixing includes: firstly, adding the titanium source, the alkyl alcohol solvent, the chemical reactant and the cosolvent into a reactor, uniformly stirring, and then adding the polymer particles thereto.

In the present disclosure, after the mixing is completed, under a sealed condition and with a first stirring, the mixture is heated to a temperature of 170-200° C., and preferably 180-190° C.; and the mixture is subjected to a reaction at the temperature for 5-10 h, and preferably 6-8 h.

In the present disclosure, in some embodiments, the first stirring is conducted at a stirring speed of 20 to 40 r/min. In the reaction process, the titanium source and the alkyl alcohol solvent form a titanium alcohol complex, and then the titanium alcohol complex is dehydrated to form TiO₂ in the action of chemical reactants, and at the same time, the polymer is partially dissolved.

After the reaction is completed, a resulting reaction system is subjected to pressurization to a pressure of 7-15 MPa, and is subjected to a second stirring at an increased stirring speed than that of the first stirring for 1-1.5 h, such that the polymer particles become a polymer fluid and that a nano-flower-shaped TiO₂ is formed by an impact from the polymer fluid and the alkyl alcohol solvent, to obtain a spinning solution. The spinning solution is then sprayed through spinneret holes by releasing pressure, and the solvent is volatilized to form polymer fibers, to obtain the fiber material with antibacterial function. In a critical state, there is a viscosity difference between the polymer and the solvent. Then, under the impact of the polymer fluid, flow marks are formed on the surface of TiO₂ particles; thus, TiO₂ shows a nano-flower-shaped morphology finally.

In the present disclosure, in some embodiments, a gas used in the pressurization is at least one of argon, nitrogen, and carbon dioxide. In the present disclosure, the resulting reaction system is subjected to pressurization to a pressure of 7-15 MPa, and preferably 9-13 MPa. In some embodiments, the second stirring is conducted at a stirring speed of 100-200 r/min, and preferably 120-180 r/min.

In the present disclosure, the polymer is promoted to be in a fluid state through high temperature and high pressure. Due to the viscosity difference between the polymer and the solvent, TiO₂ is repeatedly impacted irregularly by the solvent and polymer fluid, forming flow marks on surfaces of TiO₂ particles, which is similar to surfaces of shellfish in tidal area (washed by sand and seawater together), resulting in that TiO₂ shows a nano-flower-shaped morphology finally. After the second stirring is completed, a spinning solution is obtained.

In the present disclosure, the spinning solution is sprayed out by instantly releasing the pressure. In the present disclosure, in some embodiments, the spinneret holes each have a diameter of 10-50 cm.

In the present disclosure, in some embodiments, after the polymer fiber is formed, the method further includes: subjecting the polymer fibers to airflow splitting and collecting resulting split fibers by a conveyor belt to obtain a fiber material with antibacterial function, where the fiber material is an antibacterial non-woven material.

In the present disclosure, in some embodiments, the airflow splitting is conducted at an airflow speed of 20 to 200 m/s, and preferably 50 to 150 m/s. Through the airflow splitting, the spinning solution is formed into microfibers under pulling force, so that the obtained non-woven material has good antibacterial property and good air permeability at the same time. In the present disclosure, in some embodiments, the resulting split fibers each have a diameter of 0.5 to 2 μm.

The present disclosure provides a fiber material with antibacterial function prepared by the method as described in above technical solutions, which comprises/consists of polymer fibers, where nano-flower-shaped TiO₂ is distributed on the surface of the polymer fibers.

In the present disclosure, nano-flower shaped TiO₂ has the characteristics of large specific surface area. Firstly, the nano-flower shaped TiO₂ could fully contact and absorb natural light, generate active oxygen (hydroxyl radical, superoxide radical and photogenerated hole) substances, and destroy the activity of bacteria, thereby inhibiting bacteria and killing bacteria. Secondly, owing to the irregular surfaces of the antibacterial agent, the antibacterial agent could be easily embedded on surfaces of the polymer, and has strong interfacial bonding force with the polymer, making the antibacterial agent not easy to be fallen off, thereby realizing a lasting antibacterial effect of the fiber material.

In the present disclosure, when the fiber material is an antibacterial non-woven material, the antibacterial non-woven material is composed of polymer fibers. In some embodiments, the polymer fibers each have a diameter of 0.5-2 μm, and the polymer fibers are densely arranged, with longitudinal breaking strength of >200 N and a transverse breaking strength of >150 N, and an air permeability of 200-400 mm/s.

The fiber material with antibacterial function and its preparation method according to the present disclosure will be described in detail with Examples, but they cannot be understood as limiting the scope of the present disclosure.

### Example 1

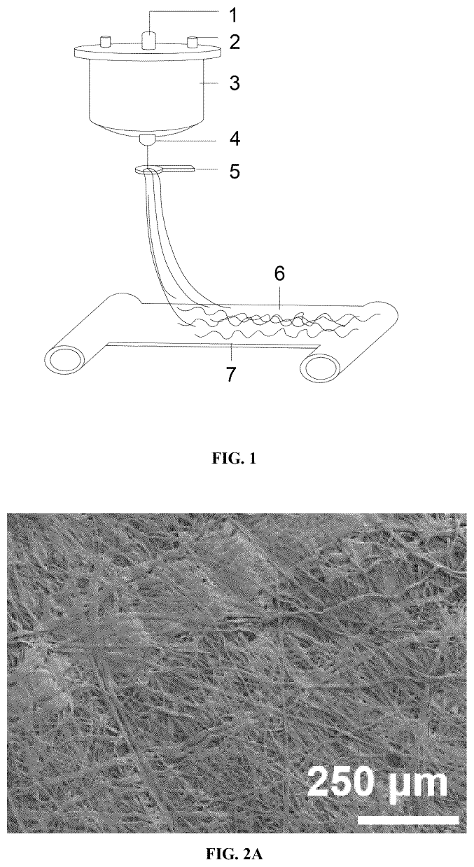

An antibacterial non-woven material was prepared by using the experimental device as shown in FIG. 1. A reactor with a capacity of 10 L was used; titanium(iv) tert-butoxide was used as a titanium source, N,N-dimethylformamide was used as a chemical reactant, isopropanol was used as a solvent, dichloroethane was used as a cosolvent, and polyethylene particles were used as polymer particles, with nitrogen as a protective gas.

1,500 g of polyethylene particles were dried in an oven at 60° C. 250 g of titanium(iv) tert-butoxide, 1,250 g of N,N-dimethylformamide, 1,500 g of isopropanol and 500 g of dichloroethane were sequentially added into the reactor through a feeding port, and a resulting material was mechanically stirred for 5 min at a stirring speed of 20 r/min. Then, the dried polyethylene particles were added into the reactor to obtain a mixture. The mixture was heated to 180° C., and further stirred for another 8 hours. Carbon dioxide gas was injected into the reactor, such that the pressure in the reactor was increased to 7 MPa. The resulting mixture was stirred at a slowly increased stirring speed until the stirring speed reached 100 r/min. After stirring for 1 h, the pressure was released, a resulting polymer solution was sprayed through spinneret holes, and the solvent in a sprayed polymer solution was volatilized to form microfiber bundles. The microfiber bundles were subjected to airflow splitting by using an airflow splitting device with an airflow speed of 150 m/s, and finally collected by a conveyor belt to obtain the antibacterial non-woven material.

Through testing and analysis, the antibacterial non-woven material has a fiber average diameter of 1.2 μm, a fiber transverse breaking strength of 160 N, a longitudinal breaking strength of 209 N, and an air permeability of 291 mm/s (tested according to the Chinese national standard GB/T1 5453-1997, analyzed and obtained by a differential pressure flowmeter, the same below). When a concentration of the antibacterial non-woven material is 0.15 mg/mL, it shows a bacteriostatic rate against Escherichia coli of 99.8%, and an antiviral activity rate against RNA virus H1N1 of 98.35%.

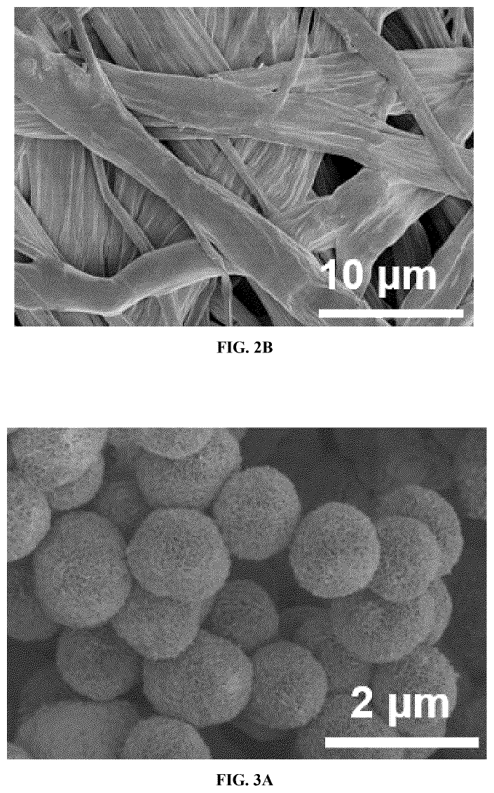

FIG. 2A to FIG. 2B show morphology diagrams of the non-woven material of Example 1, where FIG. 2A shows a surface morphology of the non-woven material, and FIG. 2B shows a morphology of the microfiber. As can be seen from FIG. 2A to FIG. 2B, the non-woven material is composed of polymer microfibers with a diameter of 0.5-2 μm, and the fibers are stacked with each other and retaining pores, resulting in that the non-woven material has good air permeability.

### Example 2

An antibacterial non-woven material was prepared by using the experimental device as shown in FIG. 1. A reactor with a capacity of 10 L was used; titanium(iv) tert-butoxide was used as a titanium source, N,N-dimethylformamide was used as a chemical reactant, ethylene glycol was used as a solvent, chloroform was used as a cosolvent, and polyester particles were used as polymer particles, with argon as a protective gas.

1,500 g of polyester particles were dried in an oven at 80° C. 250 g of titanium(iv) tert-butoxide, 1,250 g of N,N-dimethylformamide, 1,500 g of ethylene glycol and 500 g of chloroform were sequentially added into the reactor through a feeding port, and a resulting material was mechanically stirred for 5 min at a stirring speed of 20 r/min. Then, the dried polyester particles were added into the reactor to obtain a mixture. The mixture was heated to 180° C., and further stirred for another 8 hours. Argon was injected into the reactor, such that the pressure in the reactor was increased to 8 MPa. The resulting mixture was stirred at a slowly increased stirring speed until the stirring speed reached 100 r/min. After stirring for 1 h, the pressure was release, a resulting polymer solution was sprayed through spinneret holes, and the solvent in a sprayed polymer solution was volatilized to form microfiber bundles. The microfiber bundles were subjected to airflow splitting by using an airflow splitting device with an airflow speed of 200 m/s, and finally collected by a conveyor belt to obtain the antibacterial non-woven material.

Through testing and analysis, the antibacterial non-woven material has a fiber average diameter of 1.0 μm, a fiber transverse breaking strength of 163 N, a longitudinal breaking strength of 211 N, and an air permeability of 298 mm/s. When a concentration of the antibacterial non-woven material is 0.15 mg/mL, it shows a bacteriostatic rate against Escherichia coli of 99.8%, and an antiviral activity rate against RNA virus H1N1 of 98.57%.

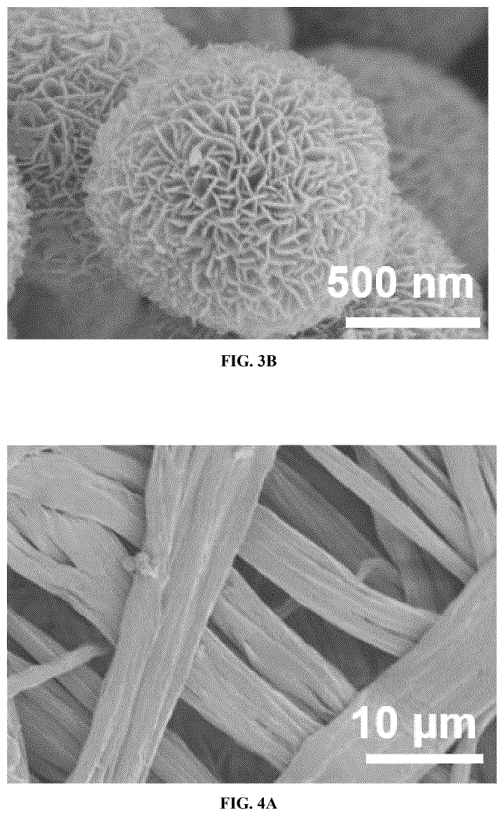

FIG. 3A to FIG. 3B show morphology diagrams of the antibacterial agent of Example 2, where FIG. 3A shows an aggregation state of the antibacterial agent, and FIG. 3B shows a surface morphology of the antibacterial agent. As can be seen from FIG. 3A to FIG. 3B, the antibacterial agent particles are uniform in size, and have a micro-nano scale size and have a flower-shaped surface.

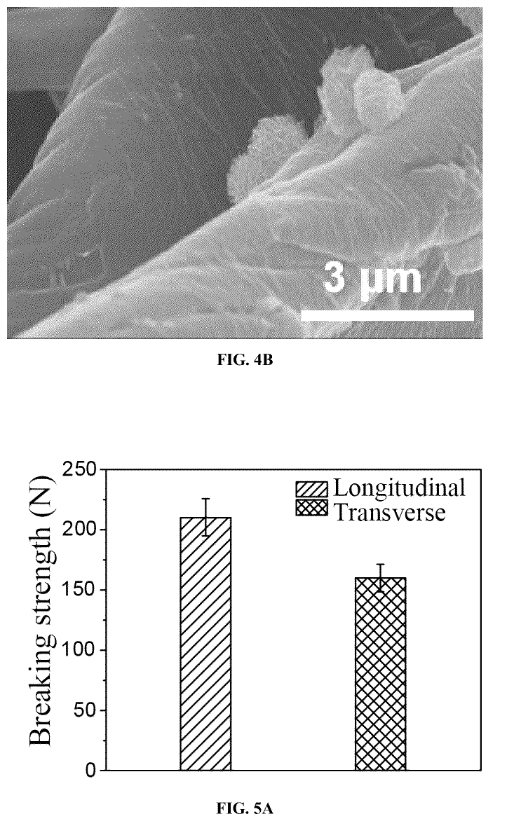

FIG. 4A to FIG. 4B show morphology diagrams of the antibacterial non-woven material of Example 2, where FIG. 4A shows a surface morphology of the antibacterial non-woven material, and FIG. 4B shows an enlarged morphology of the antibacterial non-woven material. As can be seen from FIG. 4A to FIG. 4B, antibacterial agents are uniformly dispersed on the surfaces of non-woven materials and fibers, and the flower-shaped morphology of the surface is embedded on the surface of fibers, which improves the antibacterial durability of the fibers.

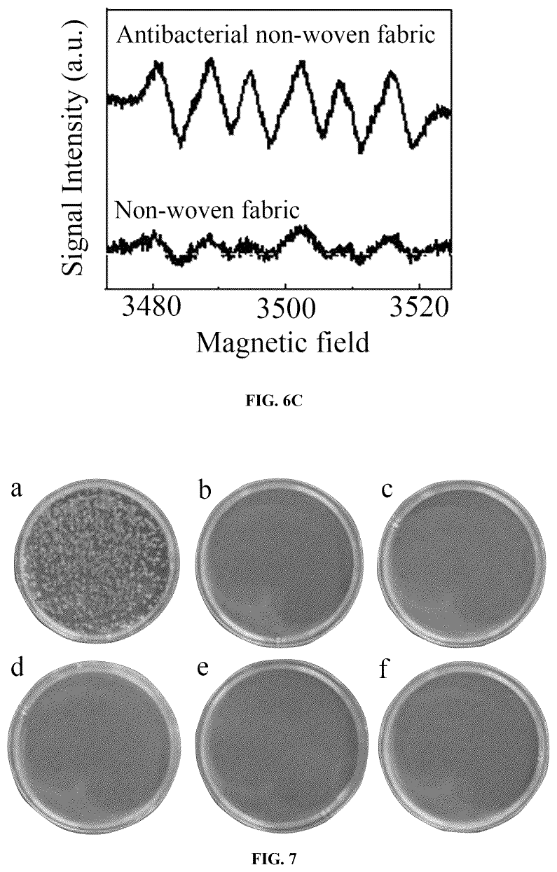

FIG. 7 shows antibacterial performance diagrams of the antibacterial non-woven material of Example 2. Through the shaking test, where panel a corresponds to a blank control, and panels b-d represent inhibition effect diagrams against Escherichia coli colonies at different non-woven material concentrations; specifically, panel b represents an inhibition effect against Escherichia coli colonies at a non-woven material concentration of 0.075 mg/mL, panel c represents an inhibition effect against Escherichia coli colonies at a non-woven material concentration of 0.1 mg/mL, panel d represents an inhibition effect against Escherichia coli colonies at a non-woven material concentration of 0.125 mg/mL, panel e represents an inhibition effect against Escherichia coli colonies at a non-woven material concentration of 0.15 mg/mL, and panel f represents an inhibition effect against Escherichia coli colonies at a non-woven material concentration of 0.175 mg/mL. As can be seen from FIG. 7, the antibacterial non-woven material of Example 2 has a good antibacterial effect against Escherichia coli.

### Comparative Example 1

An antibacterial non-woven material was prepared by using the experimental device as shown in FIG. 1. A reactor with a capacity of 10 L was used; N,N-dimethylformamide was used as a chemical reactant, isopropanol was used as a solvent, dichloroethane was used as a cosolvent, and polyethylene particles were used as polymer particles, with nitrogen as a protective gas.

1,500 g of polyethylene particles were dried in an oven at 60° C. 1,250 g of N,N-dimethylformamide, 1,500 g of isopropanol and 500 g of dichloroethane were sequentially added into the reactor through a feeding port, and a resulting material was mechanically stirred for 5 min at a stirring speed of 20 r/min. Then, the dried polyethylene particles were added into the reactor to obtain a mixture. The mixture was heated to 180° C., and further stirred for another 8 hours. Nitrogen was injected into the reactor, such that the pressure in the reactor was increased to 15 MPa. The resulting mixture was stirred at a slowly increased stirring speed until the stirring speed reached 100 r/min. After stirring for 1 h, the pressure was released, a resulting polymer solution was sprayed through spinneret holes, and the solvent in a sprayed polymer solution was volatilized to form microfiber bundles. The microfiber bundles were subjected to airflow splitting by using an airflow splitting device with an airflow speed of 150 m/s, and finally collected by a conveyor belt to obtain the antibacterial non-woven material.

Through testing and analysis, the antibacterial non-woven material has a fiber average diameter of 0.9 μm, a fiber transverse breaking strength of 157 N, a longitudinal breaking strength of 201 N, and an air permeability of 292 mm/s. When a concentration of the antibacterial non-woven material is 0.15 mg/mL, it shows a bacteriostatic rate against Escherichia coli of 0.12%, and an antiviral activity rate against RNA virus H1N1 of 5.24%.

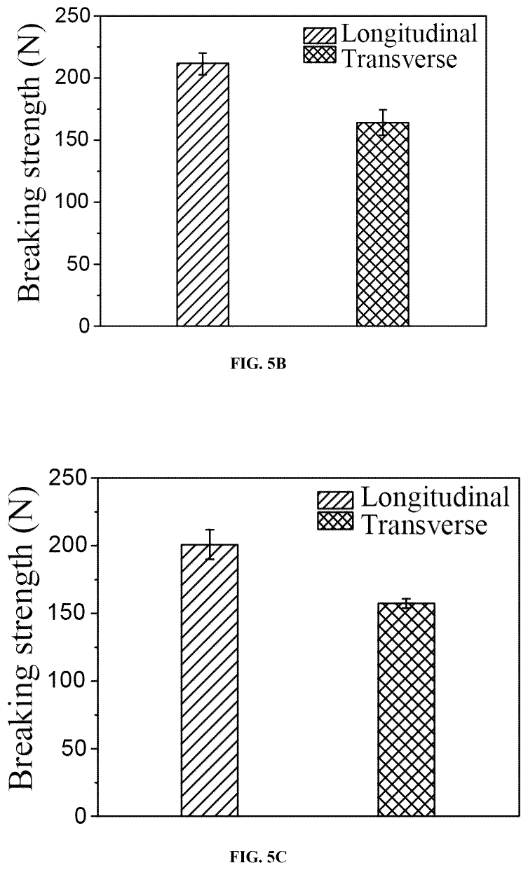

FIG. 5A to FIG. 5C show mechanical properties of the non-woven materials in Examples 1-2 and Comparative Example 1, where FIG. 5A shows mechanical properties of the non-woven materials in Example 1, FIG. 5B shows mechanical properties of the non-woven materials in Example 2, and FIG. 5C shows mechanical properties of the non-woven materials in Comparative Example 1. As can be seen from FIG. 5A to FIG. 5C, the non-woven materials prepared in Examples 1-2 and Comparative Example 1 all have a longitudinal breaking strength of greater than 200 N, and a transverse breaking strength of greater than 150 N.

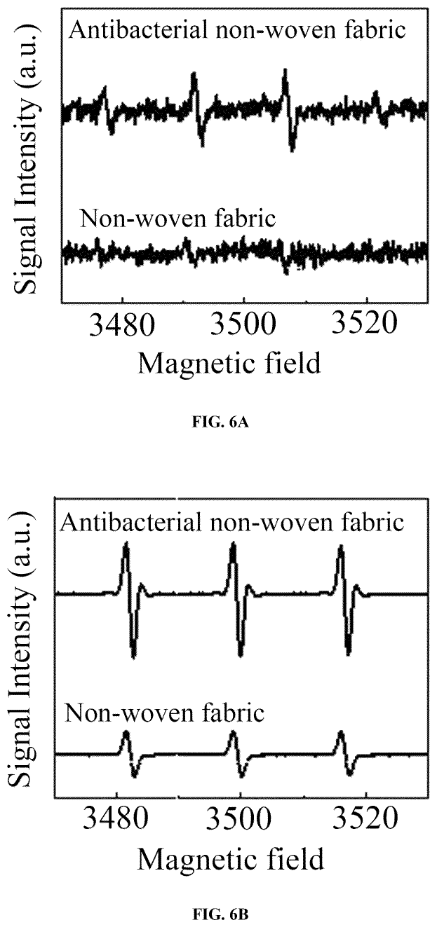

FIG. 6A to FIG. 6C show electron paramagnetic resonance spectra of the non-woven material in Comparative Example 1 (i.e., a non-woven fabric in FIG. 6A to FIG. 6C) and the antibacterial non-woven material in Example 2 (i.e., an antibacterial non-woven fabric in FIG. 6A to FIG. 6C) under light irradiation. The spin trapping agents are ·OH (FIG. 6A), h⁺(FIG. 6B) and ·O₂⁻(FIG. 6C) respectively. As can be seen from FIG. 6A to FIG. 6C, the non-woven material of the present disclosure could generate reactive oxygen species (hydroxyl radical, superoxide radical, and photogenerated hole) under illumination conditions, and has strong oxidizability, which could be used for oxidizing and killing bacteria.

Based on Examples 1-2 and Comparative Example 1, it can be concluded that: (1) the antibacterial non-woven materials are prepared by in-situ synthesis of antibacterial agents and instantaneous pressure release method, which simplifies the manufacturing process and thereby reduces the production cost and time compared with the traditional preparation process; (2) from the results of Examples 1-2, it can be seen that the antibacterial non-woven material prepared by the present disclosure has the characteristics of good antibacterial property, high breaking strength and strong air permeability; (3) from Examples 1-2 and Comparative Example 1, it can be concluded that the non-woven materials composed of microfibers could also be prepared without the titanium source. The titanium source is the precursor of main antibacterial agent and the key component to endow non-woven materials with antibacterial function.

The above is only the preferred embodiment of the present disclosure, and it should be pointed out that those skilled in the art could make several improvements and modifications without departing from the principle of the present disclosure, and these improvements and modifications should also be regarded as falling within the scope of the present disclosure.

What is claimed is:

1. A method for preparing a fiber material with antibacterial function, comprising:
mixing raw materials comprising a titanium source, an alkyl alcohol solvent, a chemical reactant, a cosolvent and polymer particles to obtain a mixture;
under a sealed condition and with a first stirring, heating the mixture to a temperature of 170-200° C, and conducting a reaction at the temperature for 5-10 h; wherein during the reaction, the titanium source and the alkyl alcohol solvent form a titanium alcohol complex, and the titanium alcohol complex is dehydrated under an action of the chemical reactant to form TiO₂; and the chemical reactant comprises at least one selected from the group consisting of N,N-dimethylformamide and N,N-dimethylacetamide;
pressurizing a resulting reaction system to a pressure of 7-15 MPa, and performing a second stirring at an increased stirring speed than that of the first stirring for 1-1.5 h such that the polymer particles become a polymer fluid and that a nano-flower-shaped TiO₂ is formed by an impact from the polymer fluid and the alkyl alcohol solvent, to obtain a spinning solution; and
spraying the spinning solution by releasing the pressure through spinneret holes, and volatilizing solvents to form polymer fibers, obtaining the fiber material with antibacterial function.

2. The method of claim 1, wherein the titanium source is at least one selected from the group consisting of titanium (iv) tert-butoxide, titanium tetrachloride, and titanium sulfate.

3. The method of claim 1, wherein the alkyl alcohol solvent has 5 or less carbon atoms.

4. The method of claim 1, wherein the polymer particles comprise at least one selected from the group consisting of polyethylene particles, polypropylene particles, polyester particles and polyamide particles.

5. The method of claim 1, wherein the cosolvent comprises at least one selected from the group consisting of dichloroethane and dichloromethane.

6. The method of claim 1, wherein based on 100% in terms of a mass of the raw materials, the titanium source accounts for 5-8%, the chemical reactant accounts for 25-35%, the alkyl alcohol solvent accounts for 30-37%, the cosolvent accounts for 10-15%, and the polymer particles account for 5-30%.

7. The method of claim 2, wherein based on 100% in terms of a mass of the raw materials, the titanium source accounts for 5-8%, the chemical reactant accounts for 25-35%, the alkyl alcohol solvent accounts for 30-37%, the cosolvent accounts for 10-15%, and the polymer particles account for 5-30%.

8. The method of claim 3, wherein based on 100% in terms of a mass of the raw materials, the titanium source accounts for 5-8%, the chemical reactant accounts for 25-35%, the alkyl alcohol solvent accounts for 30-37%, the cosolvent accounts for 10-15%, and the polymer particles account for 5-30%.

9. The method of claim 4, wherein based on 100% in terms of a mass of the raw materials, the titanium source accounts for 5-8%, the chemical reactant accounts for 25-35%, the alkyl alcohol solvent accounts for 30-37%, the cosolvent accounts for 10-15%, and the polymer particles account for 5-30%.

10. The method of claim 5, wherein based on 100% in terms of a mass of the raw materials, the titanium source accounts for 5-8%, the chemical reactant accounts for 25-35%, the alkyl alcohol solvent accounts for 30-37%, the cosolvent accounts for 10-15%, and the polymer particles account for 5-30%.

11. The method of claim 1, wherein the first stirring is conducted at a stirring speed of 20-40 r/min; and the second stirring is conducted at a stirring speed of 100-200 r/min.

12. The method of claim 1, wherein a gas used in the pressurizing is at least one selected from the group consisting of argon, nitrogen, and carbon dioxide.

13. The method of claim 1, wherein after the polymer fibers are formed, the method further comprises: subjecting the polymer fibers to airflow splitting and collecting resulting split fibers by a conveyor belt.

14. A fiber material with antibacterial function prepared by the method of claim 1, comprising the polymer fibers, wherein nano-flower-shaped TiO₂ is distributed on a surface of the polymer fibers.

15. The fiber material with antibacterial function of claim 14, wherein the titanium source is at least one selected from the group consisting of titanium (iv) tert-butoxide, titanium tetrachloride, and titanium sulfate.

16. The fiber material with antibacterial function of claim 14, wherein the alkyl alcohol solvent has 5 or less carbon atoms.

17. The fiber material with antibacterial function of claim 14, wherein the polymer particles comprise at least one selected from the group consisting of polyethylene particles, polypropylene particles, polyester particles and polyamide particles.

18. The fiber material with antibacterial function of claim 14, wherein the cosolvent comprises at least one selected from the group consisting of dichloroethane and dichloromethane.

19. The fiber material with antibacterial function of claim 14, wherein based on 100% in terms of a mass of the raw materials, the titanium source accounts for 5-8%, the chemical reactant accounts for 25-35%, the alkyl alcohol solvent accounts for 30-37%, the cosolvent accounts for 10-15%, and the polymer particles account for 5-30%.
